(19) United States
(12) Patent Application Publication
(10) Pub. No.: US 2007/0170742 A1
(43) Pub. Date: Jul. 26, 2007

(54) Land, air or sea vehicle having a transport compartment for accommodating cargo and/or seats mounted to the vehicle for conveying personnel

(76) Inventor: Holger Hansen, Hamburg (DE)

Correspondence Address: ROBERT W. BECKER & ASSOCIATES, 707 HIGHWAY 333, SUITE B, TIJERAS, NM, 87059-7507, US

(21) Appl. No.: 10/590,745

(22) PCT Filed: Feb. 24, 2005
(86) PCT No.: PCT/EP05/01911

§ 371 Date: Aug. 25, 2006

(30) Foreign Application Priority Data
Feb. 25, 2004 (DE) 10 2004 009 557.4
Dec. 20, 2004 (DE) 10 2004 062 350.3

(51) Int. Cl. B60N 2/00

(52) U.S. Cl. 296/64

(57) ABSTRACT

A land, air or sea vehicle having a transport compartment for accommodating cargo and/or seats and comprising at least one row of seats disposed next to one another in the longitudinal axis of the vehicle, and oriented transverse to the direction of movement of the vehicle, is provided in a central row of the transport compartment. Mesh frameworks of textile straps are suspended between roof and floor surfaces of the transport compartment and oppositely disposed side walls that extend in the direction of movement. Each seat is individually secured to one of the mesh frameworks which is secured, under tension, to the vehicle. Each mesh framework is comprised of two transverse straps and two vertical straps. The straps are spaced from one another by the width of the seat. The transverse straps are suspended between the side walls in the vicinity of the roof, and the vertical straps are suspended between the roof and floor. The transverse straps and the vertical straps are interconnected at their points of intersection.

The invention relates to a land, air or sea vehicle having a transport compartment for accommodating cargo and/or seats mounted to the vehicle for conveying personnel, whereby at least one row of seats disposed next to one another in the longitudinal axis of the vehicle and oriented transverse to the direction of movement of the vehicle is provided in a central row of the transport compartment.

A vehicle, especially an aircraft, having the aforementioned features is known in use. To the extent that in particular military aircraft, in addition to conveying cargo, are also used for conveying personnel and hence at least sometimes serve as troop transports, seats that serve for conveying personnel are to be installed in the respective transport compartment of the aircraft and are generally disposed next to one another in the longitudinal axis of the vehicle, although transverse to the direction of the movement of the vehicle. Although a seat arrangement along the outer side walls of the vehicle is easier to realize, special problems arise when arranging seats in the so-called central row, because here the seats have to be freely anchored without the possibility of attachment to the side walls. For this purpose, it is known from use in the central row to anchor tubular structure to the floor of the vehicle to which a seat structure is then attached.

Such an equipping of a vehicle has the drawback that the tubular structure, including the associated anchoring devices for the seats, must be very rigid since in the longitudinal axis of the vehicle, during accelerations and decelerations, especially taking into account crash situations, correspondingly high forces can occur. In addition, the seats should be capable of being quickly mounted and also removed in order to enable a change of the type of use of the vehicle for conveying personnel or for conveying cargo.

It is known from DE 43 03 719 or U.S. Pat. No. 3,868,143 to fix a seat in a vehicle for conveying personnel in the interior of the transport compartment of the vehicle by means of individual holding straps that are disposed above and below the seat.

It is an object of the present invention to improve a vehicle of the aforementioned type in such a way that seats for conveying personnel can be installed in the vehicle in a simple and quick to realize but also reliable securement.

The realization of this object, including advantageous embodiments and further developments of the invention, result from the content of the patent claims that follow this description.

The basic concept of the invention is that mesh frameworks composed of textile straps are suspended, within the pattern of the seats that are to be installed, between the oppositely disposed side walls, which extend in the direction of movement of the vehicle, and the roof and floor surfaces of the transport compartment, and that each seat is individually secured to an associated mesh framework which is secured, under tension, to support elements of the vehicle, whereby each mesh framework is comprised of two transverse straps and two vertical straps, wherein the transverse straps are spaced from one another by the width of the seat and are suspended between the side walls in the vicinity of the roof, wherein the vertical straps are spaced from one another by the width of the seat and are suspended between the roof surface and the floor surface, and wherein the transverse straps and the vertical straps are interconnected at the points where they intersect one another. The invention has the advantage that the mesh framework, which is comprised of textile straps, on the one hand imparts the necessary stability for supporting the seats due to the arrangement suspended in the vehicle, yet on the other hand the mesh framework is easy to remove, so that the entire area of the transport compartment is available for conveying cargo. In this connection, the mesh frameworks that are associated with the seats that are respectively to be disposed requires so little space that they can also be carried on board the aircraft with only a minimum impact on the capacity for conveying cargo. As a result, a correspondingly large free space results with regard to deciding how to use the vehicle.

Pursuant to one embodiment of the invention, where a double row back-to-back arrangement of two seats is provided, the mesh framework, to accommodate the two seats, includes a doubled arrangement of vertical straps such that each of the two seats has associated with it its own vertical straps, which are connected to the unitary transverse straps. In this way, a dedicated connection is imparted to each individual seat in the vertical axis.

Pursuant to embodiments of the invention, to provide the necessary pre-tension either a strap-tensioning mechanism is disposed in each of the transverse straps and of the vertical straps, or a central strap-tensioning mechanism is disposed in the mesh framework composed of transverse straps and vertical straps.

To the extent that vertical straps and transverse straps must be interconnected at their points of intersection for stability reasons, the vertical straps and transverse straps can be sewn together at their points of intersection, resulting in a unitary mesh framework the free ends of which are respectively anchored by being fixed to the vehicle. Alternatively, however, it is also possible to connect the vertical straps and transverse straps at their points of intersection by disposing, preferably by sewing, eyelets in one of the two straps to which the respective other straps are connected by detachable connecting means, for example by carabiner hooks, shackles or the like.

Pursuant to another embodiment of the invention, to improve stability of the mesh framework a support structure of textile support straps is disposed between two vertical straps suspended apart by the width of a seat and is tensioned with the vertical straps, whereby pursuant to an embodiment of the invention the support structure comprises two intersecting support straps suspended in the plane of the vertical straps and two support straps that extend linearly between the vertical straps, and the ends of the support straps are respectively connected to the vertical straps. If the support structure is also to be placed under tension, pursuant to an embodiment of the invention a strap-tensioning mechanism can be disposed in the support structure formed from the support straps.

If also for reasons of stability preferably each individual seat, or two back-to-back seats, are to have associated therewith a single mesh framework composed of transverse straps and vertical straps, the invention does not preclude, where two mesh frameworks are disposed next to one another in the longitudinal axis of the vehicle, that the adjacent mesh frameworks are each connected to a common transverse strap and/or vertical strap.

To the extent that with the configuration of the mesh framework in the interior of the transport compartment the possibility is provided for connecting correspondingly suitable seats, pursuant to the invention the holding straps that belong to the seat can be anchored partially to the mesh framework and partially to anchoring points attached to the vehicle. In this connection, the anchoring of the holding straps to the vehicle is in particular applicable for the holding straps that extend between the seat and the floor surface, while the holding straps that extend in the direction of the roof surface of the transport compartment can be suspended on the transverse straps of the mesh framework that are suspended in the vicinity of the roof. It is to be understood that in the frame of such seats, which are preferably embodied as textile seats, a lateral seat boundary that is suspended at the level of the head of the vehicle occupant can be provided in order, in a manner known per se, to cushion accelerations/decelerations that act in the longitudinal axis of the vehicle, and hence transverse to the occupant of the seat.

To the extent that pursuant to further embodiments of the invention a seat having a safety harness to secure an occupant of the seat is fixed to the vertical straps of the mesh framework, to support the seat pan, which is embodied as a component that is resistant to pressure, support straps that respectively laterally border the seat pan are secured to the vertical straps, whereby when the seat pan is in the sitting position a portion of the lateral support straps extends from a lower securement position with the vertical straps along the side edges of the seat pan up to their front corners, and from there, following a course that is inclined relative to the vertical axis, are guided back to the vertical support straps and are secured thereto at an upper securement location, the seat pan, in the strap structure that holds it and that is comprised of the vertical straps and the lateral support straps, can be folded or pivoted between its sitting position and a storage position by raising the rear end of the seat pan that is associated with the vertical support straps.

This first of all has the advantage that the seat pan is supported by the strap structure that borders it and is composed of the vertical support straps and the lateral support straps secured thereto, without thereby requiring other fixed components in the vehicle; rather, the seat pan, which for this purpose is embodied as a component that is resistant to pressure, appropriately suspends the strap structure. The freedom of movement for the occupant in the vehicle is thereby already improved. A further advantageous improvement results from the foldable arrangement of the seat pan within the strap structure since when not being used this seat pan can be folded against the vertical straps disposed in the region of the back support, and can thereby be brought into the storage position. This ability to fold the seat pan furthermore considerably improves the comfort when entering and leaving the safety seat. For example, when getting out of the safety seat, the rear seat edge of the seat pan can be pulled up, whereby the front edge of the seat pan pivots downwardly, and hence the indicated strap structure for supporting the seat pan is relaxed. Climbing into the safety seat occurs by simultaneously squatting on and pressing down the rear end of the seat pan, whereby the tensioning of the seat pan within the strap structure that supports it is effected by the weight of the body of the occupant sitting thereon.

A safety seat embodied as a textile shell that surrounds the back as well as the side of an occupant's body is known from DE 43 03 719 A1.

Pursuant to an embodiment of the invention, the rearward end of the seat pan extends between the vertical support straps and is guided between them during its folding or pivoting movement. The seat pan, which is resistant to pressure, thereby simultaneously also tensions the vertical straps.

Pursuant to an embodiment of the invention, to bring the seat pan from the sitting position into the storage position, and as a helpful position when getting out of the safety seat, a control portion is connected to the rear end of the seat pan and is guided over a guide member located in the region of the roof of the vehicle, with the control portion having a handle or grip loop that is supported on the roof portion of the vehicle. If the occupant stands up out of the safety seat, by the simultaneous unloading of the body weight from the seat pan, and the pulling on the grip loop of the control portion, the seat pan is brought into the storage position, so that a lateral climbing out or later climbing in is no longer obstructed.

Pursuant to embodiments of the invention, the seat pan can be comprised of a solid plate or also of a tubular frame having a textile seating surface supported thereby. Alternative embodiments of a combination of a frame that is resistant to pressure with textile seating surfaces are possible.

Pursuant to an embodiment of the invention, the lateral support straps are fixed on the seat pan at the front corners thereof, so that the seat pan is fixed relative to the strap structure that supports it and that is composed of the lateral support straps and the vertical straps, and is thereby guided during its folding movement.

Pursuant to embodiments of the invention, the lateral support straps can be embodied as one-piece belt straps or as two individual strap portions that are each connected with the vertical straps and the seat pan.

To the extent that such safety seats are additionally also to be provided with an impact or collision protection for the head of the occupant, pursuant to one embodiment a textile head support is suspended as a head collision protection in the plane of the back support between the vertical straps; the head support continues in lateral support surfaces that are disposed above the lateral support straps and which at their front free ends are connected to a holding strap that extends from an upper securement point on the roof region of the vehicle to the lower securement point of the vertical strap at the floor of the vehicle at an angle to the vertical axis of the vehicle. Due to its particular, inclined course within the vehicle, the additional holding straps limit only slightly the freedom of movement of the occupant when climbing into or out of the seat, and at the same time also offer adequate elbow room for the occupant of the seat.

The head supports can be made of a partially transparent textile material.

Pursuant to a further improvement, the holding strap can be provided with an actuatable, detachable tensioning mechanism; this provides the possibility of being able to loosen the holding strap while climbing in or climbing out, and hence of additionally removing the lateral support surfaces out of the entry or exit region of the seat.

If pursuant to an embodiment of the invention an additional textile collision matting is secured to the vertical straps between the back support and the region of the head support suspended between the vertical supports, the advantage is provided that when safety seats are disposed in rows in a vehicle, the person sitting behind a safety seat is protected from a front impact since the head of the rear occupant, as it executes a dipping movement due to a forward acceleration, is cushioned by the collision matting on the front seat.

With regard to the configuration of the collision matting, it can be unitarily embodied with that portion of the textile head support that is disposed between the vertical straps.

The back support can be embodied as a strap suspended between the vertical straps, or as an appropriately disposed textile fabric or as a reinforced panel.

Embodiments of the invention are shown in the drawing, which will be described subsequently and in which:

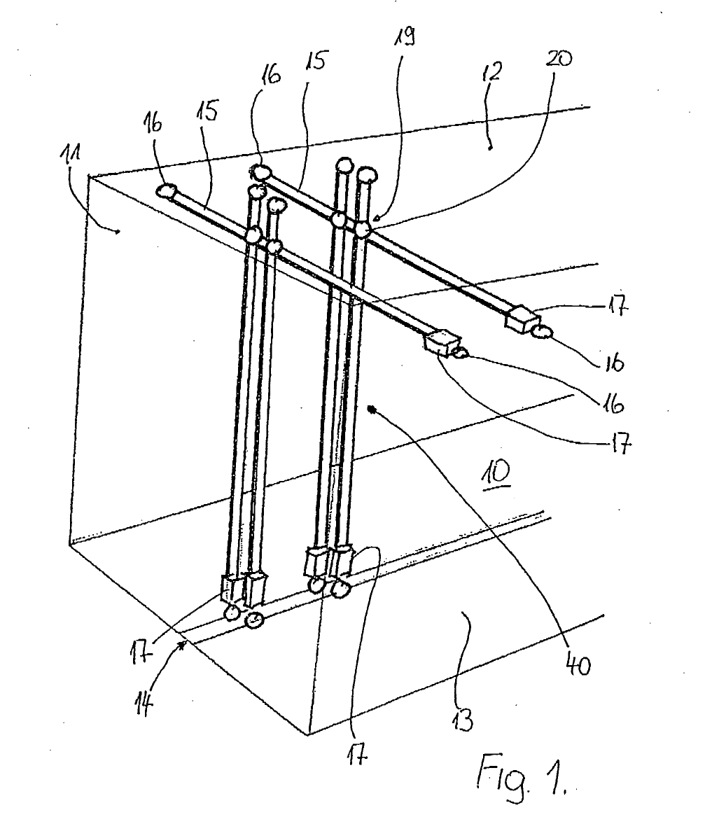

FIG. 1 is a schematic illustration of the transport compartment of a vehicle having a mesh framework suspended therein,

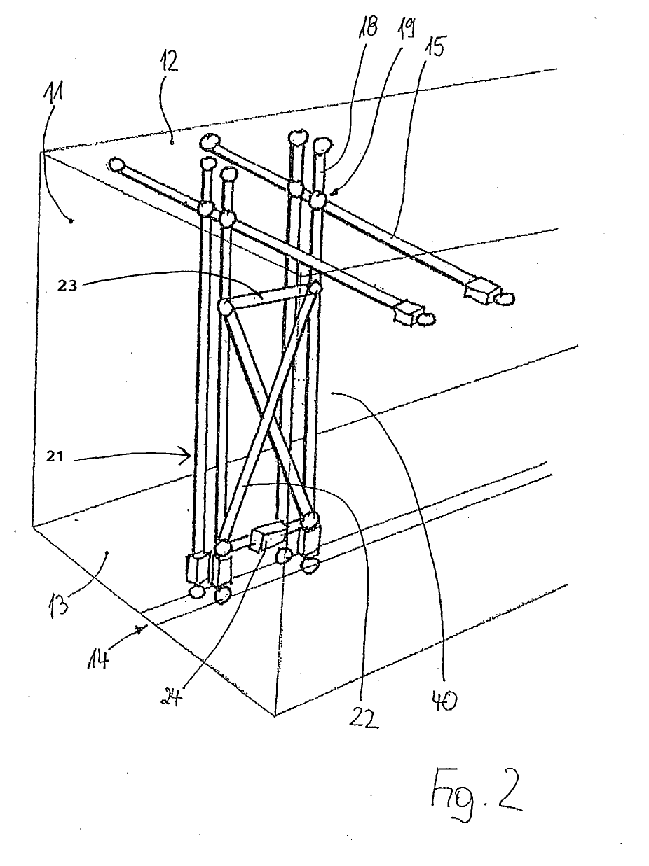

FIG. 2 shows the subject matter of FIG. 1 with an additional support structure for the vertical straps of the mesh framework,

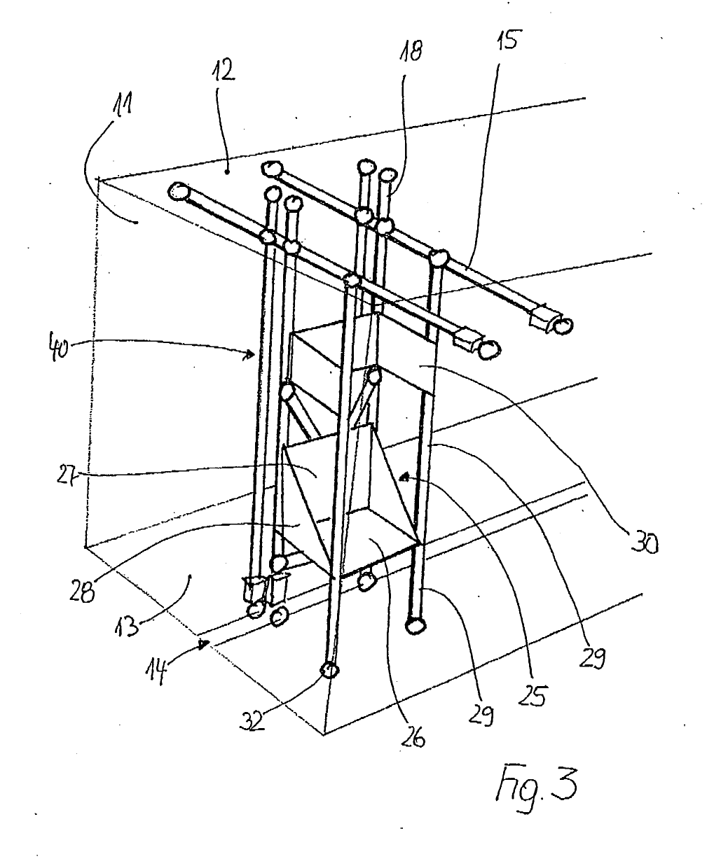

FIG. 3 shows the subject matter of FIG. 2 with a seat supported on the mesh framework,

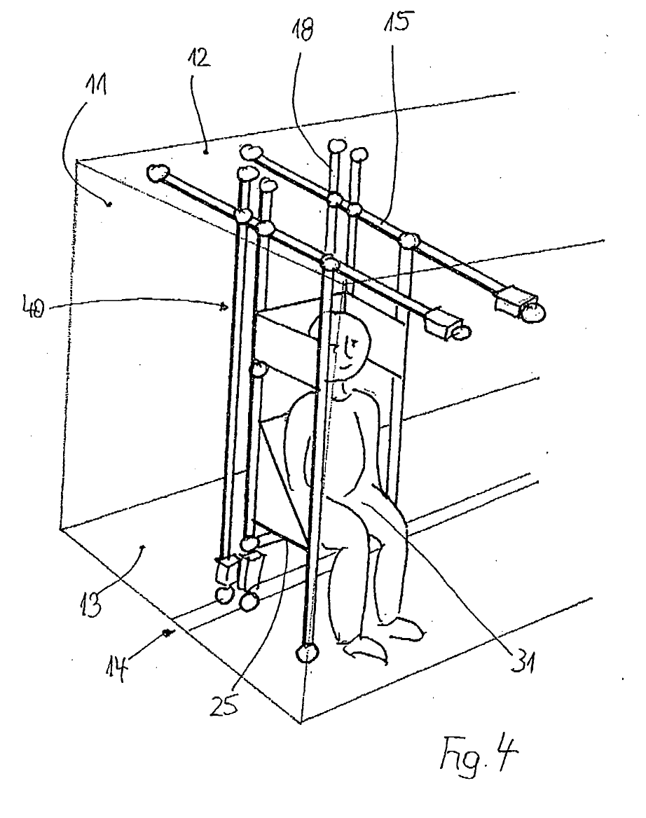

FIG. 4 shows the subject matter of FIG. 3 with a person seated in the seat,

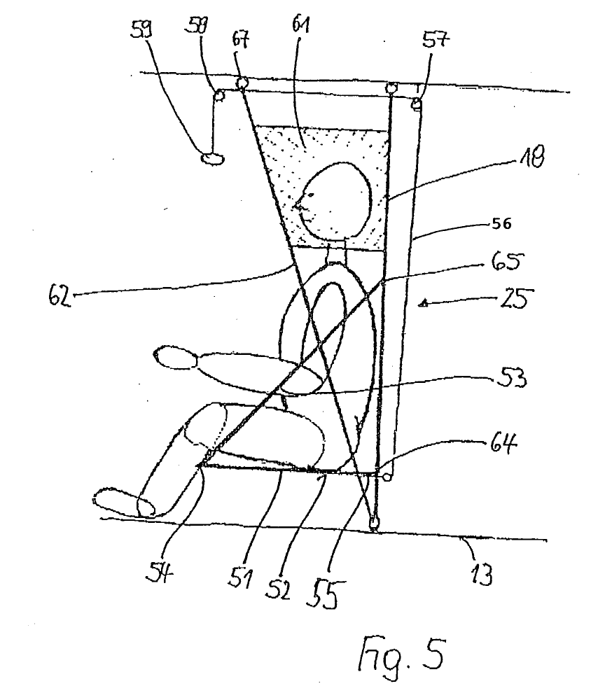

FIG. 5 is a schematic side view of a safety seat disposed in a vehicle with an occupant seated thereon,

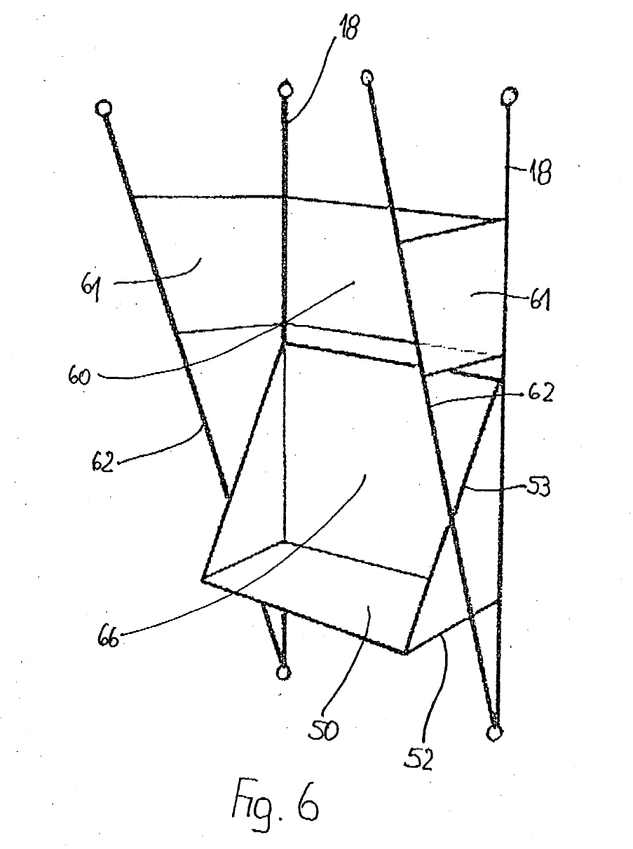

FIG. 6 is a view of the safety seat of FIG. 5 without an occupant,

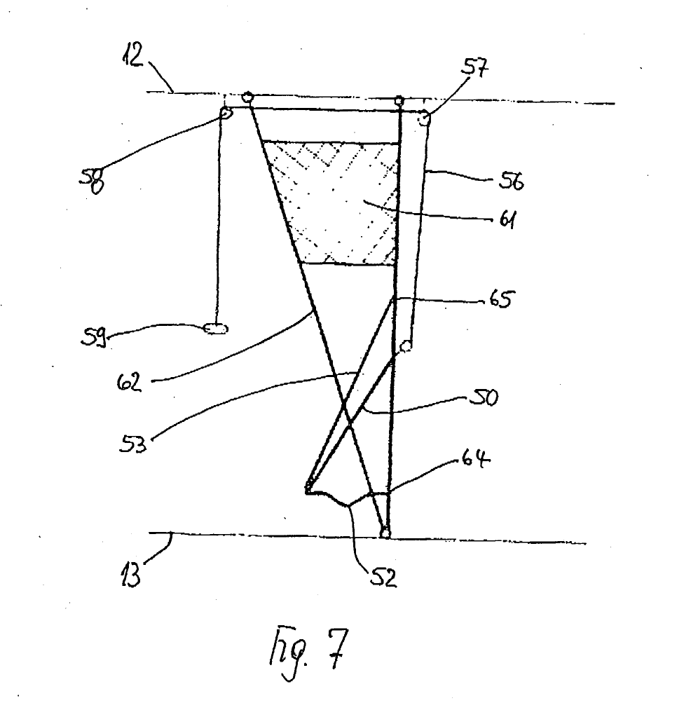

FIG. 7 shows the safety seat of FIG. 5 or 6 in the unused storage position of a seat pan,

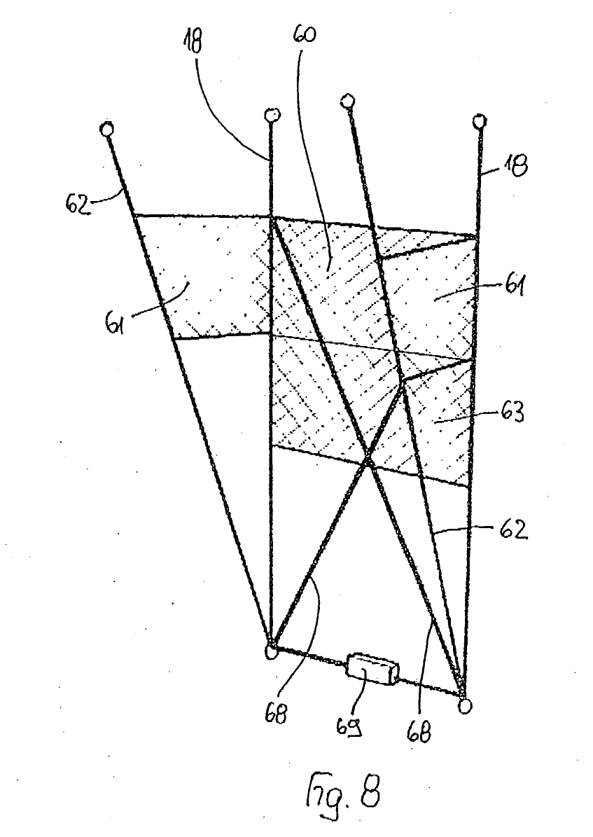

FIG. 8 is a schematic illustration of the configuration of a head support.

A schematically illustrated transport compartment 10 of a land, air or sea vehicle, especially however of an aircraft, is enclosed by side walls 11, which extend in the direction of movement of the vehicle, a roof 12, and a floor 13. In particular, the invention is concerned with the arrangement of seats (FIGS. 3 and 4) in the central row 14 of the transport compartment 10, and to this extent the mesh framework 40 that is visible in FIG. 1 is directed to the central row 14.

This mesh framework 40 is comprised primarily of two transverse straps 15, which are suspended or otherwise extend between the oppositely disposed side walls 11 in the vicinity of the roof 12, yet spaced therefrom; the transverse straps are spaced apart by the width of a seat, and their end anchor ties 16 are secured to the side walls 11 in a force-transmitting manner. In the illustrated embodiment, a respective strap-tensioning mechanism 17 is disposed in the two transverse straps 15.

Disposed in the region of the central row 14 are vertical straps 18 that extend in the vertical axis of the transport compartment 10, and in particular again two respective vertical straps that are spaced apart by the width of a seat. Although not illustrated, if two individual seats are to be mounted in a back-to-back arrangement on the mesh framework 40, the mesh framework 40 includes a total of four vertical straps 18, the respective end anchor ties 16 of which are anchored to the roof 12 and floor 13 respectively. It may be judicious to use two respective vertical straps 18 that are spaced apart by the width of a seat for supporting each seat. As is the case with the transverse straps 15, a respective strap-tensioning mechanism 17 is disposed in each vertical strap 18.

If for reasons of a stable mesh framework the transverse straps 15 and the vertical straps 18 are to be interconnected at the points 19 where they intersect, in the illustrated embodiment eyelets 20 are incorporated into one of the two straps and the other strap, in a manner not shown in detail, is secured to the eyelet by means of a detachable connection, preferably by means of shackles or carabiners. If the mesh framework 40 is to be configured as a unitary mesh framework, it is also possible to stitch all ends of the transverse straps 15 and vertical straps 18 that intersect in an eyelet 20 respectively directly with the eyelet 20.

It should also be noted that with the illustration of FIG. 1, as well as with the FIGS. 2 to 4 that are to be described subsequently, an idealized illustration is shown, since when tension is exerted in the mesh framework 40, in particular the transverse straps 15 no longer retain their linear course, but rather are inclined in a V-shaped manner in the direction of the point of connection of the vertical straps 18. A similar situation exists when, pursuant to FIGS. 3 and 4, the holding straps, which will be described subsequently, for supporting the seats on the mesh framework are attached to the transverse straps and similarly, due to the tension that is exerted, alter the illustrated linear course of the transverse straps 15.

As can be seen from FIG. 2, to improve stability, in particular in the vertical axis region, the mesh framework 40 is provided with a support structure 21 that is suspended between two vertical straps 18 and which is composed of an arrangement of two support straps 22 that cross one another, and two support straps 23 that are disposed linearly between the vertical straps 18. The support structure 21 is respectively connected with the vertical straps 18, whereby the connection can be embodied in the same manner as was explained with respect to the points of intersection 19 of the transverse straps 15 and vertical straps 18. An additional strap-tensioning mechanism 24 is disposed in the lower support strap 23 of the support structure 21. To facilitate illustration, FIG. 2 does not illustrate that a support structure 21 having the same configuration is also disposed between the two further vertical straps 18 that are provided for supporting the second seat, so that on the whole a symmetrical configuration of the mesh framework 40 and support structures 21 results.

A seat 25, illustrated schematically in FIG. 3, is now connected to the thus-prepared mesh framework; the seat is provided with a sitting surface 26, a back portion 27 and side parts 28. Holding straps respectively lead from the corner points of the schematically illustrated seat 25 in the direction of the roof 12 as well as in the direction of the floor 13, whereby in the illustration of FIG. 3, only those holding straps 29 that respectively engage at the front ends of the seat 25 are shown. The free ends of these holding straps 29 are on the one hand suspended at additional anchor ties 32 to the floor 13 and on the other hand at the transverse straps 15 of the mesh framework 40, while the rear, non-illustrated holding straps are connected with the vertical straps 18. As a result, the seat 25 is fixed to the suspended mesh framework 40.

In order when the aforementioned accelerations or decelerations, which act in the direction of the central row 14, occur to be able to support the head of the vehicle occupant, head nets 30 are suspended between the respective holding straps of the seat 25, at the level of a head; the head nets are again indicated only schematically.

FIG. 4 finally shows the sitting position of a vehicle occupant that is sitting in the seat 25.

As described above, a corresponding seat 25 is anchored in a back-to-back arrangement on the vertical straps 18, which are not specifically shown in FIGS. 2 to 4.

As shown in FIGS. 5 and 6, the safety seat 25 is fixed on vertical straps 18 that are vertically suspended between the vehicle roof 12 and the vehicle floor 13. In this connection, the safety seat 25 in particular has a seat pan 50 that is embodied as a component that is resistant to pressure and that is fixed on the vertical straps 18 via additional lateral support straps 51 that are connected with the vertical straps 18 and form therewith a strap structure for supporting the seat pan 50. In this connection, the lateral support straps 51 comprise a portion 52 that extends from a lower securement location 64, along the side edges of the seat pan 50, to the front corners 54 thereof, whereby from the front corners 54 of the seat pan 50, a further portion 53, which respectively extends at an incline relative to the vertical axis of the vehicle, is guided back to an upper securement location 65 on the associated vertical strap 18. The seat pan 50, which is embodied as a component resistant to pressure, is thus placed into the strap structure formed of vertical straps 18 and support straps 51 in such a way that the seat pan automatically tensions the strap structure.

A control portion 56 engages the rear end 55 of the seat pan 50; the control portion leads to a guide member 57 that is secured to the vehicle roof 12, where it changes direction is guided via a further guide member 58 into a position in front of the occupant of the safety seat 25, and ends in a handle or grip loop 59.

The safety seat 25 is furthermore provided with an impact or collision protection for the head that is comprised of a textile head support 60 that is suspended above a backrest or back support 66 between the vertical straps 18. The head support 60 changes direction into two lateral support surfaces 61 that are disposed above the lateral support straps 51 and are attached at their front ends to a holding strap 62. The associated holding straps 62 extend from a securement 67 on the vehicle roof 12 disposed above the front region of the seat pan 50, following a course that is inclined relative to the vertical axis of the vehicle, to the securement of the vertical strap 18 on the vehicle floor 13.

For additional protection it is possible, as shown in FIG. 8, to suspend below the textile head support 60 an additional textile collision matting 63 between the vertical straps 18 to catch or support the head of an occupant seated behind this safety seat upon the occurrence of negative vehicle accelerations.

In the embodiment illustrated in FIG. 8, to reinforce the strap structure diagonal straps 68 are additionally suspended between the vertical straps 18, and can be tensioned by an associated tensioning mechanism 69.

The advantageous operation of the safety seat can be seen in particular from FIG. 7 in conjunction with FIG. 5. When standing up out of the safety seat, the occupant grasps the grip loop 59 suspended in front of him and pulls it down; at the same time, the occupant rises from the seat pan 50, thereby relieving the pressure thereon. Both movement processes lead to the folding of the seat pan 50 into the storage position illustrated in FIG. 7 since the rear end of the seat pan 50 slides up between the vertical straps 18, and the front edge of the seat pan 50 drops correspondingly. This reinforces the standing-up movement of the occupant, and the occupant is so-to-speak tipped out of the safety seat.

If the position on the safety seat is to be assumed, the occupant pulls on the front side of the seat pan to pull it somewhat out of its storage position, and subsequently seats himself or herself thereon; in so doing, the seat pan, under the weight of the occupant, automatically tensions the strap structure composed of the vertical straps 18 and the lateral support straps 51.

The features of the subject matter of these documents disclosed in the preceding specification, the patent claims, the abstract and the drawing can be important individually as well as in any desired combination with one another for realizing the various embodiments of the invention.

1-24. (canceled)

25. In combination with a land, air or sea vehicle having a transport compartment for accommodating cargo and/or seats mounted to the vehicle for conveying personnel, at least one row of seats disposed next to one another in a longitudinal axis of the vehicle and oriented transverse to a direction of movement of the vehicle, wherein said at least one row of seats is provided in a central row of said transport compartment, wherein mesh frameworks composed of textile straps are suspended, within the pattern of the seats that are to be installed, between roof and floor surfaces of said transport compartment and oppositely disposed side walls that extend in the direction of movement of the vehicle, wherein each seat is individually secured to an associated one of said mesh frameworks which in turn is secured, under tension, to support elements of the vehicle, wherein each mesh framework is comprised of two transverse straps and two vertical straps, wherein said transverse straps are spaced from one another by the width of the seat and are suspended between said side walls in the vicinity of said roof surface, wherein said vertical straps are spaced from one another by the width of the seat and are suspended between said roof surface and said floor surface, and wherein said transverse straps and said vertical straps are interconnected at points where they intersect one another.

26. The combination of claim 25, wherein a double-rowed back-to-back arrangement of two seats is provided, and wherein said mesh framework, to accommodate the two seats, includes a doubled arrangement of said vertical straps such that each of the two seats has associated therewith its own vertical straps that are connected to unitary ones of said transverse straps.

27. The combination of claim 25, wherein a strap-tensioning mechanism is disposed in each of said transverse straps and each of said vertical straps, or wherein a central strap-tensioning mechanism is disposed in said mesh framework that is composed of said transverse straps and said vertical straps.

28. The combination of claim 25, wherein said vertical straps and said transverse straps are sewn together at their points of intersection.

29. The combination of claim 25, wherein in order to connect said vertical straps and said transverse straps at their points of intersection, eyelets are disposed in one of said straps to which the respectively other strap is connected via detachable connection means.

30. The combination of claim 25, wherein a support structure of textile straps, which is held in place by said vertical straps, is disposed between two vertical straps that are suspended at a seat width apart.

31. The combination of claim 30, wherein said support structure is comprised of two intersecting support straps suspended in a plane of said vertical straps, and two further support straps that extend between said vertical straps, and wherein ends of said intersecting support straps and further support straps are respectively connected to said vertical straps.

32. The combination of claim 30, wherein a strap-tensioning mechanism is disposed in said support structure that is composed of said intersecting support straps and said further support straps.

33. The combination of claim 25, wherein two mesh frameworks disposed next to one another in the longitudinal axis of the vehicle are provided, and wherein said adjacent mesh frameworks are respectively connected to a common transfer strap and/or vertical strap.

34. The combination of claim 25, wherein a seat is provided that is to be secured to the vehicle via holding straps disposed above and below the seat, and wherein said holding straps belonging to the seat are adapted to be partially anchored to said mesh framework (40) and partially anchored to anchoring means attached to the vehicle.

35. The combination of claim 25, wherein a seat is provided that is to be secured to said vertical straps of said mesh framework and that has a safety harness for securing an occupant of the seat, wherein to support a seat pan that is embodied as a component that is resistant to pressure, lateral support straps that respectively laterally border said seat pan are secured to said vertical straps, wherein when said seat pan is in a sitting position a portion of said lateral support strap extends from a lower securement location with said vertical straps along side edges of said seat pan to front corners of said seat pan and from there, following a course inclined relative to a vertical axis, is guided back to said vertical straps and is secured thereto at an upper securement location, and wherein said seat pan, in a strap structure that holds it and that is comprised of said vertical straps and said lateral support straps, is adapted to be folded or pivoted between its sitting position and a storage position by a raising of a rear end of said seat pan associated with said vertical straps.

36. The combination of claim 35, wherein said rear end of said seat pan extends between said vertical straps and is guided between said vertical straps during a folding or pivoting movement.

37. The combination of claim 35, wherein a control portion is connected to said rear end of said seat pan, wherein said control portion is guided over a guide member located in said roof surface of the vehicle, and wherein said control portion has a handle means supported on said roof surface of the vehicle.

38. The combination of claim 35, wherein said seat pan is comprised of a solid panel or of a tubular frame having a textile seating surface supported thereby.

39. The combination of claim 35, wherein said lateral support straps are fixed to said seat pan at said front corners thereof.

40. The combination of claim 35, wherein said lateral support straps are embodied as one-piece belt straps or are comprised of two individual strap portions that are respectively connected to said vertical straps and said seat pan.

41. The combination of claim 35, wherein a textile head support is suspended, as a head impact or collision protection, in a plane of a back support between said vertical straps, wherein said head support continues in lateral support surfaces disposed above said lateral support straps, and wherein said lateral support surfaces are connected at front free ends thereof to a support strap that, at an incline to the vertical axis of the vehicle, extends from an upper securement point on said roof surface of the vehicle to a lower securement point of said vertical strap to said floor surface of the vehicle.

42. The combination of claim 41, wherein said head support is made of a partially transparent textile material.

43. The combination of claim 41, wherein said holding strap is provided with an actuatable detachable tensioning device.

44. The combination of claim 41, wherein an additional textile collision matting is secured to said vertical straps between said back support and that portion of said head support that is suspended between said vertical straps.

45. The combination of claim 44, wherein said collision matting is unitarily formed with that portion of said textile head support that is disposed between said vertical straps.
